(19) United States
(12) Patent Application Publication
(10) Pub. No.: US 2026/0259364 A1
(43) Pub. Date: Sep. 3, 2026

(54) LUMINOUS LAMINATED GLASS PANEL COMPRISING A FUNCTIONAL COATING

(71) Applicant: SAINT-GOBAIN GLASS FRANCE, COURBEVOIE (FR)

(72) Inventors: Corentin MONMEYRAN, AUBERVILLIERS (FR); Mathieu BERARD, AUBERVILLIERS (FR); Julie RUFF, HERZOGENRATH (DE)

(21) Appl. No.: 18/873,064

(22) PCT Filed: Jun. 8, 2023
(86) PCT No.: PCT/FR2023/050813

§ 371 Date: Dec. 9, 2024

(30) Foreign Application Priority Data
Jun. 9, 2022 (FR) FR2205564

(51) Int. Cl. F21V 8/00; C03C 17/34

(52) U.S. Cl. CPC G02B 6/0051; C03C 17/3435; C03C 2217/213; C03C 2217/231; C03C 2217/281; C03C 2217/948; C03C 2218/156

(57) ABSTRACT

A material intended for luminous laminated glazings, includes a substrate coated with a functional coating including, starting from the substrate optionally a first dielectric coating located beneath the functional layer, including a layer having a higher refractive index and a layer having a lower refractive index, a functional layer based on a transparent conductive oxide, a second dielectric coating located above the functional layer, including a layer having a higher refractive index and a layer having a lower refractive index, the layer with higher refractive index has a refractive index greater than that of the layer with lower refractive index and the refractive index variation at 550 nm between these two layers is greater than 0.25, the sum of the optical thicknesses of the first and second dielectric coatings is greater than 200 nm.

The invention relates to the field of luminous glazings. A luminous glazing is a glazing that emits light. It comprises a light source and a substrate comprising on one of its main faces a light-extracting layer such as a patterned diffusing layer. The light source is optically coupled to the substrate, for example via the edge. Light injected at the substrate edge propagates into the substrate by total internal reflection. The substrate acts as a light guide.

According to the present invention, light propagation in the substrate by total internal reflection is referred to as the “guided mode”. The guided mode thus corresponds to the use of grazing-incidence light inside a substrate. The critical parameter for the guided mode is the critical angle of total internal reflection. It corresponds to the angle relative to the normal to the substrate above which any light ray arriving on a separating surface or interface, from a medium with a higher optical index towards a medium with a lower optical index, is completely reflected by said surface or interface. The critical angle (θc) is determined by applying the Snell-Descartes equation. It corresponds to the angle (in the substrate) at which the light ray is refracted at 90° (in the medium of lower index than the substrate).

For luminous glazings, the surrounding medium may be air, another substrate or a polymeric interlayer. For example, the critical angle of total internal reflection at the interface between a glass substrate with a refractive index of 1.51 and the air is around 40°. In the case of a glass/polyvinyl butyral (PVB) polymer interlayer interface, the critical angle is around 80°.

All the light rays injected into the substrate that have an angle of incidence:
above this critical angle are reflected and continue to propagate in the substrate,
below this critical angle are partially refracted and gradually leave the substrate.

In the case of luminous glazing, the light sources used are preferably light-emitting diodes (LEDs). Light is extracted at the extracting layer, illuminating the pattern.

There is a growing demand for luminous glazing for automotive applications, particularly for car roofs. However, this option is not compatible with most of the glazings traditionally used for these applications. This is because automotive glazings must also have a low-emissivity function to reduce the amount of energy dissipated to the outside. The “low-E” function or property refers to a glazing's ability to inhibit heating while reflecting infrared radiation.

To this end, functional coatings with infrared (IR) radiation reflection properties are used. In the following description, the term “functional” means “capable of controlling solar radiation and/or infrared radiation”. Examples include functional coatings comprising a conductive oxide layer sandwiched between two dielectric coatings. We are particularly familiar with patent application WO2018/206236. This application discloses, starting from the substrate, functional coatings comprising:
a dielectric coating comprising dielectric layers such as silicon nitride and/or silicon oxide layers,
a functional layer based on a transparent conductive oxide (TCO), such as a layer based on indium tin oxide (ITO),
a dielectric coating comprising dielectric layers such as silicon nitride and silicon oxide layers.

The absorption of visible light by the conductive oxide-based functional layers of these functional coatings is non-negligible, particularly in the red. However, the absorption of visible light at normal incidence remains low, as the light passes perpendicularly through the conductive oxide functional layer. The interaction between the radiation and the functional layer takes place only on the thickness of the functional layer (ef).

The situation is different for guided-mode light. When the functional coatings are placed close to the substrate in which the light propagates in guided mode, the light propagating in the substrate is likely to interact with the functional layer. The interaction angles between the light of the guided mode and the substrate are defined directly in the substrate into which light is injected. The rays of the guided mode are therefore largely “grazing” (θ greater than) 80° with respect to the normal to the substrate in which they propagate.

A guided mode ray therefore passes through the functional layer over a distance corresponding to: Functional layer thickness (ef)/cos (θ). The steeper the angle, the lower the cos (θ), the greater the distance over which the guided mode rays interact with the functional layer, and therefore the greater the proportion of absorbed rays.

In conclusion, when the substrate in which the light propagates comprises or is in contact with a functional coating, a significant portion of the light comes into contact with this functional coating at a grazing angle and is therefore likely to be absorbed when the functional coating comprises absorbing layers.

This is why, depending on the light injected, there is an alteration, a chromatic change, a reduction or even an erasure of the pattern as one moves away from the point of light injection due to the high guided mode absorption of the functional layer at grazing angles.

This problem is particularly acute at long visible wavelengths, as the absorption of conductive oxide layers, and ITO in particular, increases with wavelength. In the case of luminous glazings, the guided-mode optical properties of the functional coating are therefore decisive.

When using light sources emitting red light (red LEDs), the guided absorption of red wavelengths results in a color (or brightness) that fades along the pattern (when moving away from the light source). When using light sources that emit white light, guided-mode absorption of red wavelengths results in fading color and brightness that dims along the pattern.

The applicant, aware of this phenomenon, was interested in controlling the distribution of electromagnetic energy in the stack by means of an interference effect. The aim is to minimize the energy density in the functional layer and thus minimize absorption, particularly in the red.

The absorption of light energy into a coating due to the presence of an absorbent layer depends both on the thickness and material of the layer, as well as on the position of the layer within the coating. In particular, the local amplitude of the electric field in a coating layer depends on its position in the coating, which functions as an interference filter. The absorption of light energy varies proportionally to the square of the amplitude of this electric field. If the so-called absorbing layer is placed at a point in the coating where the amplitude of the electric field for a given wavelength is low, the absorption of this wavelength will be lower compared to a coating comprising the same absorbing layer placed at a point where the amplitude of the electric field is greater.

It is possible to selectively increase or reduce the absorption properties of a coating at certain wavelengths. To achieve this, the “position” of the absorber layer can be advantageously selected by placing it at a point in the coating where the amplitude of the electric field for that wavelength is great or small. To select the most advantageous “position” from the point of view of absorption, the thickness and nature of the dielectric layers of the dielectric coatings surrounding the functional layer can be varied.

The applicant has therefore demonstrated that by selecting the nature and thicknesses of the dielectric layers making up the dielectric coatings of the functional coatings, it is possible to selectively reduce red absorption in guided mode without affecting other properties and functions, particularly low emissivity and aesthetics.

To achieve this goal, it was necessary to characterize the functional coating's absorption of light in guided mode. It is not possible to determine colorimetric parameters experimentally, since the guided mode exists only in the substrate. The inventors have developed a specific optical model for simulating a* and b* values in guided-mode reflection at the substrate/functional coating interface. This reflection corresponds to an angle of incidence of 80° in the glass substrate. These colorimetric parameters in guided mode are called Rgm, a*gm and b*gm. Rgm corresponds to the total amount of light reflected at each reflection on the layered interface. Lower red absorption in guided mode translates into higher Rgm values and into less negative, or even neutral, a*gm and b*gm values. A high Rgm parameter denotes low absorption and therefore better preservation of the guided mode in terms of its total intensity.

Thanks to this model, the applicant has been able to develop families of solutions meeting these criteria in the form of particular combinations of dielectric layers in dielectric coatings with specific thicknesses and optical indices.

The present invention therefore relates to a material comprising a substrate coated with a functional coating, intended for use in luminous glazing, with low guided-mode absorption in the visible range, particularly in the red range, when the glazing is illuminated, thus avoiding any color drift along the length of the pattern.

The improvement results from precise control of optical interference effects between the different layers making up the coating. This control is achieved by selecting the type, thickness and sequence of dielectric layers making up the dielectric coatings. This makes functional coatings compatible with use in luminous glazings.

The invention relates to a material comprising a substrate coated with a functional coating comprising, starting from the substrate:
optionally a first dielectric coating below the functional layer comprising:
a layer with higher refractive index with an optical thickness of between 0 and 110 nm, and
a layer with lower refractive index with an optical thickness of between 0 nm and 170 nm,
the layer with higher refractive index if present, has a higher refractive index than the layer with lower refractive index, if present, and the refractive index variation at 550 nm between these two layers is greater than 0.25, greater than 0.30, or greater than 0.40,
a functional layer based on a transparent conductive oxide (TCO),
a second dielectric coating located above the functional layer comprising:
a layer with higher refractive index with an optical thickness of between 80 and 170 nm, and
a layer with lower refractive index with an optical thickness of between 80 and 190 nm,
the layer with higher refractive index has a refractive index greater than that of the layer with lower refractive index and the refractive index variation at 550 nm between these two layers is greater than 0.25, greater than 0.30, or greater than 0.40,
the sum of the optical thicknesses of the first and second dielectric coatings is greater than 200 nm.

Surprisingly, the best results in terms of low red absorption in guided mode, low emissivity and/or neutral aesthetics in transmission are obtained with a functional coating having the following characteristic(s):
the functional layer is selected from fluorine-doped tin oxide, antimony-doped tin oxide and/or indium tin oxide,
the functional layer has a geometric thickness of between 70 and 200 nm, between 75 and 150 nm, between 80 and 130 or between 90 and 110 nm,
the dielectric layers of the dielectric coatings with lower refractive index have a refractive index of less than 1.7, less than 1.6, or less than 1.5,
the layers with lower refractive index are silicon oxide-based layers,
the dielectric layers of the dielectric coatings with higher refractive index have a refractive index greater than 1.9, or greater than 2.0,
the dielectric layers of each dielectric coating higher refractive index are chosen from:
layers based on nitride of one or more elements selected from silicon, aluminum or zirconium, preferably based on silicon nitride,
layers based on zinc tin oxide,
zinc oxide-based layers, or
titanium oxide-based layers,
the dielectric layers of the dielectric coatings with lower refractive index are identical or different and are chosen from silicon oxide-based layers,
the dielectric layers of the dielectric coatings with higher refractive index are identical or different and are chosen from silicon nitride or zinc-tin oxide layers.

In particular, the applicant has identified two particularly advantageous combinations featuring particular ranges of optical thickness for each dielectric layer of the dielectric coatings. This means that by selecting a functional coating satisfying one of these range combinations, it is possible to obtain a number of the advantageous properties sought by the invention. However, any selection within these combinations does not provide all the preferred properties of the invention.

According to a first preferred combination, the invention relates to a material of which:
the dielectric coating located below the functional layer comprises:
   a layer with higher refractive index with an optical thickness of between 0 nm and 20 nm,
   a layer with lower refractive index with an optical thickness of between 0 nm and 25 nm, preferably 10 and 20 nm,
the dielectric coating located above the functional layer comprises:
   a layer with higher refractive index with an optical thickness of between 100 nm and 140 nm,
   a layer with lower refractive index with an optical thickness of between 80 and 140 nm.

According to the invention, the lower limit in the ranges “between 0 nm” means that the layer can be absent. The terminal is therefore included.

According to a first preferred combination, the invention relates to a material of which:
the dielectric coating located below the functional layer comprises:
   a layer with higher refractive index with an optical thickness of between 40 nm and 110 nm or between 60 and 80 nm,
   a layer with lower refractive index with an optical thickness of between 20 nm and 145 nm or between 75 and 105 nm,
the dielectric coating located above the functional layer comprises:
   a layer with higher refractive index with an optical thickness of between 80 nm and 170 nm or between 90 and 130 nm,
   a layer with lower refractive index with an optical thickness of between 125 nm and 190 nm or between 150 and 165 nm.

According to this advantageous combination, the sum of the optical thicknesses of the first and second dielectric coatings is greater than 300 nm, 350 nm, 380 nm or 400 nm.

Advantageously, the invention offers colors with a low intensity of reflection at 60°.

The invention also relates to a laminated glazing comprising a material according to the invention and at least one second substrate, the material and the second substrate are interconnected by a first laminating interlayer.

Conventionally, the faces of a glazing are designated starting from the exterior by numbering the faces of the substrates from the outside toward the inside of the passenger compartment or of the premises which it equips. This means that the incident sunlight passes through the faces in increasing numerical order.

In the case of a laminated glazing, all the faces of the substrates are numbered but the faces of the laminating interlayers are not numbered.

The laminated glazing according to the invention comprises a face 1 on the outside of the building or vehicle it equips, the faces 2 and 3 in contact with the laminating interlayer and a face 4 on the inside of the building or vehicle. The functional coating is preferably positioned on face 4.

The invention also relates:
a laminated glazing according to the invention mounted on a vehicle or on a building, and
to the use of a laminated glazing according to the invention as low-E glazing for buildings or vehicles,
to a building or vehicle comprising a glazing according to the invention.

The laminated glazing according to the invention is preferably an automotive glazing, such as an automotive roof glazing.

The laminated glazing according to the invention may comprise curved substrates.

The laminated glazing can have a light transmission of less than 50%, less than 30%, less than 20% or less than 10%.

The laminated glazing can also have a light transmission of over 60%, over 70% or over 80%.

The invention also relates to a luminous glazing comprising a laminated glazing according to the invention, a light source optically coupled to form a light guide, and a light extractor element for extracting the guided light.

The light source is preferably peripheral.

The light source is preferably optically coupled to the substrate of the material according to the invention. The optical coupling can be:
via the edge of the substrate of the material of the invention,
via a wall delimiting a hole, preferably a through-hole, in the substrate of the material, or
via light redirection, for example, the source can be located on side F4 (offset or opposite face F4) and a light redirection element such as a reflective prismatic film is positioned on face F3.

The light-extracting element is preferably a diffusing element, in particular a patterned layered diffusing element.

The luminous glazing of the invention can be selected from a side window, rear window, roof window or windscreen.

The preferred features which appear in the remainder of the description are applicable as well to the material according to the invention as, where appropriate, to the glazing, the method, the use, the building or the vehicle according to the invention.

All the describes light features are obtained according to the principles and methods of the ISO 9050 standard relating to the determination of the light and solar features of the glazings used in glass for the construction industry.

Conventionally, the refractive indices are measured at a wavelength of 550 nm.

According to the invention, two elements such as layers or substrates have substantially equal refractive indices when the absolute value of the difference between the refractive indices of the two materials constituting said layers or substrates at 550 nm is less than or equal to 0.15.

The layers of higher refractive index and the layers of lower refractive index have different refractive indices. According to the invention, two elements such as layers or substrates have different refractive indices when the absolute value of the difference between the refractive indices of the two materials constituting said layers or substrates at 550 nm is greater than or equal to 0.25, greater than 0.30, greater than 0.40, greater than 0.50, greater than 0.60, greater than 0.70 or greater than 0.80.

The refractive indices are defined at the wavelength of 550 nm.

Unless otherwise mentioned, the thicknesses mentioned in the present document, without other information, are real or geometrical physical thicknesses denoted Ep and are expressed in nanometers (and not optical thicknesses). The optical thickness Eo is defined as the physical thickness of the layer under consideration multiplied by its refractive index at the wavelength of 550 nm: Eo=n*Ep. As the refractive index is a dimensionless value, it may be considered that the unit of the optical thickness is that chosen for the physical thickness.

According to the invention, a dielectric coating corresponds to a sequence of dielectric layers, located between the substrate and the functional layer, or above the functional layer.

If a dielectric coating is composed of several dielectric layers, the optical thickness of the dielectric coating corresponds to the sum of the optical thicknesses of the different dielectric layers constituting the dielectric coating.

The functional coating is deposited by magnetic-field-assisted cathode sputtering (magnetron method). According to this advantageous embodiment, all the layers of coatings are deposited by magnetic-field-assisted cathode sputtering. Unless specifically stipulated, the expressions “above” and “below” do not necessarily mean that two layers and/or coatings are positioned in contact with one another. When it is specified that a layer is deposited “in contact” with another layer or with a coating, this means that there cannot be one (or several) layer(s) inserted between these two layers (or layer and coating).

In the present description, unless otherwise indicated, the expression “based on”, used to characterize a material or a layer with respect to what it contains, means that the mass fraction of the constituent that it comprises is at least 50%, in particular at least 70%, preferably at least 90%.

According to the invention:
light reflection corresponds to the reflection of solar radiation in the visible part of the spectrum,
light transmission corresponds to the transmission of solar radiation in the visible part of the spectrum,
light absorption corresponds to the absorption of solar radiation in the visible part of the spectrum.

The light characteristics are measured using the illuminant D65 at 2° perpendicularly to the material mounted in a single glazing (unless otherwise indicated):
TL corresponds to light transmission in the visible range in %,
Rc corresponds to the exterior light reflection in the visible range in %, observer on the functional coating side,
Rs corresponds to the internal light reflection in the visible range in %, observer on the side opposite that comprising the functional coating,
a*T and b*T correspond to the colors in transmission a* and b* in the L*a*b* system,
a*Rc and b*c correspond to the colors in reflection a* and b* in the L*a*b* system, observer on the exterior space side,
a*Rs and b*Rs correspond to the colors in reflection a* and b* in the L*a*b* system, observer on the side opposite that comprising the functional coating.

The parameters a*60° and b*60° correspond to the colors a* and b* in the L*a*b* system at an angle of 60° relative to the normal to the plane of the glazing measured according to illuminant D65 at 2° perpendicular to the material mounted in a single glazing with the functional coating positioned on face 1, observer on the functional coating side.

On a clear glass substrate (single glazing), materials according to the invention make it possible to obtain:
an emissivity of less than 30%, or even less than 20%, and/or,
a low reflection Rs, notably less than 7%, and,
neutral colors in reflection, and,
low-angle reflection colors, resulting in a reflection at 60° of less than 17%, and neutral colors.

Preferably, the material confers on the glazings incorporating it the colors in transmission and in external reflection or in internal reflection (single glazing) as defined hereinafter:
a*Rc values between −8 and 4, between −2 and 2, between −2 and 1.5, and/or,
b*Rc values between −5 and +5, between −2 and 2, and/or,
a*Rc 60° values between −8 and 6, between −2 and 1.5, and/or,
b*Rc 60° values between −8 and 8, between −2 and 2.

These properties are measured on ordinary clear glass. Ordinary clear glass from 4 to 6 mm thick has the following light characteristics:
light transmittance between 87 and 91.5%,
light reflection between 7 and 9.5%,
light absorption between 0.3 and 5%.

The parameters Rgm, a*gm and b*gm correspond to the reflection and colors a* and b* in guided-mode reflection at the substrate/functional coating interface at an angle of 80° in the glass substrate.

In laminated glazing configurations, colorimetric properties are calculated using:
materials comprising a substrate coated with a functional coating mounted in a laminated glazing,
the laminated glazing comprises a material comprising a substrate comprising 2 mm ordinary soda-lime glass and another 2 mm glass substrate of soda-lime glass, the two substrates are separated by a 0.76 mm Polyvinyl Butyral (PVB) lamination interlayer,
the functional coating is preferably positioned on face 4.

The functional coating preferably comprises only one functional layer.

Preferably, the functional coating is deposited on a flat glass and the assembly is curved and tempered. This improves the emissivity of a TCO such as ITO. The functional coating can also be heated during deposition.

The dielectric layers are conventionally selected from oxide-based, nitride-based or oxynitride-based layers. The layers based on one or more elements substantially comprise oxygen and very little nitrogen. The layers based on oxide in particular comprise at least 90%, as atomic percentage, of oxygen relative to the oxygen and nitrogen in said layer. The layers based on nitride comprise essentially nitrogen and very little oxygen. The layers based on nitride comprise at least 90%, as atomic percentage, of nitrogen relative to the oxygen and nitrogen in said. The layers based on oxynitride comprise a mixture of oxygen and nitrogen. The layers based on oxynitride comprise 10 to 90% (limit values excluded), as atomic percentage, of nitrogen relative to the oxygen and nitrogen in said layer.

The amounts of oxygen and nitrogen in a layer are determined by atomic percentages relative to the total amounts of oxygen and nitrogen in the layer in question.

Dielectric layers are conventionally selected from:
layers comprising silicon, aluminum and/or zirconium, optionally doped with at least one other element,
layers based on zinc tin oxide,
titanium oxide-based layers,
zinc oxide-based layers.

The layers comprising silicon comprise at least 50% by weight of silicon relative to the weight of all the elements forming the layer comprising silicon, other than nitrogen and oxygen.

The layers comprising silicon may be selected from layers based on oxide, based on nitride or based on oxynitride, such as layers based on silicon oxide, layers based on silicon nitride and layers based on silicon oxynitride.

The layers based on silicon oxide comprise at least 90%, as atomic percentage, of oxygen relative to the oxygen and nitrogen in the layer based on silicon oxide. The layers based on silicon nitride comprise at least 90%, as atomic percentage, of nitrogen relative to the oxygen and nitrogen in the layer based on silicon nitride. The layers based on silicon oxynitride comprise 10 to 90% (limit values excluded), as atomic percentage, of nitrogen relative to the oxygen and nitrogen in the layer based on silicon oxide. The layers based on silicon oxide are preferably characterized by a refractive index at 550 nm of less than or equal to 1.55. The layers based on silicon nitride are preferably characterized by a refractive index at 550 nm of greater than or equal to 1.95.

The layers comprising silicon may comprise, or consist of, elements other than silicon, oxygen and nitrogen. These elements may be selected from aluminum, boron, titanium and zirconium. The layers comprising silicon may comprise at least 2%, at least 5%, or at least 8% by weight of aluminum relative to the weight of all the elements forming the layer comprising silicon oxide, other than oxygen and nitrogen.

The layers comprising aluminum may be selected from layers based on oxide, based on nitride or based on oxynitride, such as layers based on aluminum oxide, such as Al₂O₃, layers based on aluminum nitride, such as AlN, and layers based on aluminum oxynitride, AlOxNy.

Among the dielectric layers, a distinction is made, according to their refractive index at 550 nm, between low-refractive-index layers, medium-refractive-index layers and high-refractive-index layers. The low-refractive-index layers have a refractive index of less than 1.70. The medium-refractive-index layers have a refractive index of between 1.70 and 2.2. The high-refractive-index layers have a refractive index greater than 2.2.

The low-index layers may have a refractive index of less than 1.70, less than 1.6 or less than 1.5. The low-refractive-index layers are preferably silicon-oxide-based layers.

The layers of intermediate refractive index can be selected from:
the layers based on zinc oxide (n550=2.0),
the layers based on tin oxide (n550=2.0),
layers based on zinc tin oxide (n550=2.0),
the silicon- and/or aluminum-nitride-based layers (n550=2.1),
the silicon- and/or aluminum-oxynitride-based layers.

The high-refractive-index layers may have a refractive index:
greater than 2.30, greater than 2.35, or greater than 2.40.
less than 2.60, less than 2.50, less than 2.40.

The high-refractive-index layers can be chosen from:
the layers based on titanium oxide (n550=2.4),
the layers based on mixed oxide of titanium and another component selected from the group consisting of Zn, Zr and Sn,
the layers based on a layer of zirconium nitride,
the zirconium-silicon-nitride-based layers (n550 nm=2.20-2.40),
the layers based on a layer of zirconium oxide,
the layers based on manganese oxide MnO (n550=2.16),
the layers based on a layer of tungsten oxide (n550=2.15),
the layers based on a layer of niobium oxide (n550=2.30),
the layers based on a layer of bismuth oxide (n 550=2.60).

The layer of lower refractive index can be selected from the low refractive index layers. In this case, the layers of higher refractive index are chosen from the layers with a refractive index greater than 1.7. They are therefore chosen from intermediate refraction layers and the layers of high refractive index.

The layer of lower refractive index can be selected from the intermediate refractive index layers. In this case, the layers of higher refractive index are chosen from the layers with a high refractive index.

The sum of the physical thicknesses of all the layers comprising silicon in each dielectric coating is greater than 50%, 60% or 70% of the total thickness of the dielectric coating considered.

The substrates can be made of mineral glass or transparent polymer material. The substrates are preferably made of mineral glass.

The mineral glass substrates that make up the glazing can be soda-lime, aluminosilicate or borosilicate glass.

Substrates can be made of transparent polymeric material, including poly(methyl methacrylate) (PMMA), polycarbonate (PC), polyurethane or polyurea (PU) substrates.

Preferably, the laminating interlayers comprise one or more sheets of organic polymers. Organic polymers are selected from polyvinyl butyral (PVB), polyurethanes (PU), polyureas, ethylene vinyl acetate (EVA), polyolefins (including polyethylene (PE), polypropylene (PP) or polyisobutylene (P-IB)), polyvinyl chloride and its derivatives (for example, polyvinyl dichloride (PVDC)), styrenic polymers (for example, polystyrene (PS), acrylostyrene butadiene (ABS), styrene acrylonitrile (SAN)), polyacrylics (including polyacrylonitrile (PAN) and poly(methyl methacrylate) (PMMA)), polyesters (including poly(ethylene terephthalate) (PET) and poly(butylene terephthalate) (PBT)), polyoxymethylene (POM), polyamides (PA), fluoropolymers such as polychlorotrifluoroethylene (PCTFE), polycarbonates (PC), aromatic polysulfones including polysulfone (PSU), polyphenylene ethers (PPE), epoxies (EP) alone or in blends and/or copolymers of several of these. The lamination interlayer may be tinted.

Preferably, the substrate material is clear, or better still, extra-clear, to limit absorption.

The substrate can be ultra-thin glass, for example, with a thickness of less than 0.7 mm.

The substrate can be heat-tempered glass.

The invention also relates to a luminous glazing unit comprising a laminated glazing unit according to the invention, a light-extracting element, preferably a layered diffusing element, and light sources.

The diffusing layer element can be in contact with or formed on the face of a laminated glazing substrate by a surface treatment such as sandblasting, acid etching, or diffusing layer deposition.

Acid-etched glass, Satinovo® glass by SAINT-GOBAIN GLASS and glass with Smoothlite® diffusing coating by SAINT-GOBAIN GLASS are examples of layered diffusing elements.

The layered diffusing element can be formed in the bulk of a substrate or interlayer, for example by laser etching. The layered diffusing element in the form of a substrate or interlayer is then applied to the surface of the substrate of the material according to the invention, for example by lamination.

The layered diffusing element can be placed on the substrate of the material according to the invention, in particular on the side opposite that of the functional coating.

The layered diffusing element can be a self-supporting diffusing film, preferably bonded to a glazing substrate.

The layered diffusing element can be a layer deposited on a substrate. The coating can be based on a diffusing enamel. It can be deposited discontinuously on one side of a substrate to form a pattern. The layer can be a diffusing ink printed on a substrate or an interlayer.

The diffusing layer may comprise an organic or inorganic matrix and diffusing particles of, for example, metal oxide such as titanium dioxide. An example of a mineral transparent diffusing layer is transparent enamel as described in application FR3084355. An example of an organic transparent diffusing layer is transparent layer as described in application WO2022023638.

The diffusing elements are positioned at the desired light extraction points. In this way, light can be directed onto the glazing surface, diffusing it by means of diffusing surfaces with well-defined areas and contours, according to geometric or even text patterns, for example.

The layered diffusing element can be opaque or transparent.

The layered diffusing element may comprise a matrix (organic or mineral) and diffusing particles, for example of metal oxide (TiO2, etc.).

An example of a mineral transparent diffusing layer is transparent enamel as described in application FR3084355.

An example of an organic transparent diffusing layer is transparent layer as described in application WO2022023638.

The laminated glazing may comprise a masking layer of opaque material (particularly black), preferably on the inner main face (interlayer side) of the second substrate (face 2). This peripheral layer forms a frame and defines a clear view. Preferably, the light source is masked from the outside, in particular by the masking layer. This layer may be an enamel on the second glass substrate or an ink on the interlayer.

The light source capable of emitting light is preferably a light-emitting element such as a light-emitting diode (LED). The light source can be polychromatic (white light) or monochromatic (red light).

The light source can be linear, such as a diode array.

The light source can be coupled directly to the substrate material or via a guide, collimation optics, etc.

The light source is preferably optically coupled to the substrate of the material according to the invention. The optical coupling can be:
via the edge of the substrate of the material of the invention,
via a wall delimiting a hole, preferably a through-hole, in the substrate of the material, or
via light redirection, for example, the source can be located on side F4 (offset or opposite face F4) and a light redirection element such as a reflective prismatic film is positioned on face F3.

The light source can be located opposite or close to the edges of the substrate to be coupled through the substrate edge. Reference may be made to patent application WO2010049638.

The light source can also be placed in a hole made in the glazing (circular or oblong). Reference may be made to patent applications WO2013110885 or WO2018178591.

The light source can be located close by, for example on face 4 (offset or opposite face 4), and a light redirection element such as a reflective prismatic film is positioned to redirect the light (for example on face 3). Reference may be made to patent application WO2022096365.

Several light sources can be used, for example near opposite edges of the substrate.

The diodes can be front- or side-emitting. The diodes are preferably surface-mounted components on a support with electrically conductive tracks, such as a rectangular printed circuit board.

When the glazing is used as a rear window, the light source preferably emits red light. When the glazing is used as a rear window or windscreen, the pattern may comprise a pictogram such as a rescue triangle.

### EXAMPLES

### I. Materials and Coatings

In these examples, the glass substrates are aluminosilicate glass substrates.

The laminating interlayers are 0.76 mm Poly(vinyl butyral) (“PVB”) interlayers.

The functional layers (F) are tin indium oxide layers.

The dielectric coatings comprise:
layers based on silicon nitride (Si3N4, n550=2.0),
layers based on silicon oxide (SiO₂, n550=1.5).

The conditions for deposition of the layers, which were deposited by sputtering (“magnetron cathode” sputtering), are summarized in table 1.

TABLE 1

| Layer | Target used | Deposition pressure | | Gas |
|---|---|---|---|---|
| ITO | In₂O₃ 90%, SnO₂ | 2.10⁻³ | mbar | Ar/(Ar + O2) |
| | 10% wt | | | at 99% |
| SiO2 | Si:Al | 2.10⁻³ | mbar | Ar/(Ar + O2) |
| | (92:8% by wt) | | | at 62.5% |
| Si3N4 | Si:Al | 3.2*10⁻³ | mbar | Ar/(Ar + N2) |
| | (92:8% by wt) | | | at 55% |

Table 2 lists the materials and the physical thicknesses in nanometers (unless otherwise indicated) for each layer or coating that forms the coatings as a function of their position with respect to the substrate bearing the stack (final line at the bottom of the table).

TABLE 2

| | | Ex. 1 | | Ex. 2 | | Ex. 3 | | Ex. 4 | | Ex. 5 | | Cp. 1 | | Cp. 2 | |
|---|---|---|---|---|---|---|---|---|---|---|---|---|---|---|---|
| | | Tg | To | Tg | To | Tg | To | Tg | To | Tg | To | Tg | To | Tg | To |
| 2^{nd} | SiO₂ | 87 | 131 | 62 | 93 | 93 | 139.5 | 99 | 148.5 | 104 | 156 | 50 | 75 | 65 | 97.5 |
| DC | Si₃N₄ | 54 | 108 | 55 | 110 | 63 | 126 | 74 | 148 | 57 | 114 | 9 | 18 | 15 | 30 |
| FL | ITO | 100 | — | 100 | — | 100 | — | 100 | — | 100 | — | 72 | — | 100 | — |
| 1st | SiO₂ | 0 | 0 | 5 | 7.5 | 26 | 39 | 36 | 54 | 54 | 81 | 17 | 25.5 | 10 | 15 |
| DC | Si₃N₄ | 0 | 0 | 0 | 0 | 43 | 86 | 23 | 46 | 36 | 72 | 30 | 60 | 15 | 30 |

Substrate

| | | | | | | | | | | | | | | |
|---|---|---|---|---|---|---|---|---|---|---|---|---|---|---|
| Th. 1st DC | 0 | 0 | 5 | 7.5 | 69 | 125 | 59 | 100 | 90 | 153 | 47 | 85.5 | 25 | 45 |
| Th. 2^{nd} DC | 141 | 239 | 117 | 203 | 156 | 265.5 | 173 | 296.5 | 161 | 270 | 59 | 93 | 80 | 127.5 |
| Σ Th. DC | 141 | 239 | 122 | 210.5 | 225 | 390.5 | 232 | 396.5 | 251 | 423 | 106 | 179 | 105 | 172.5 |

DC: Dielectric coating; FL: Functional layer; Tg: Geometric thickness; To: Optical thickness; Th thickness.

### II. Illustration of the Attenuation Phenomenon

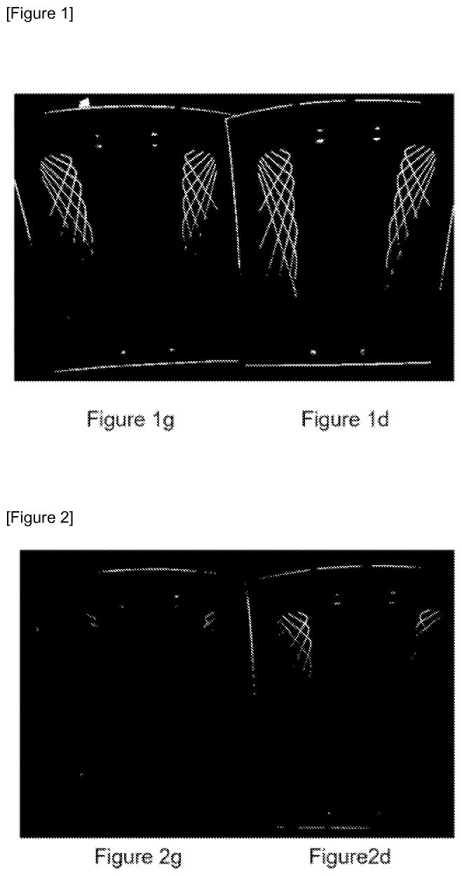

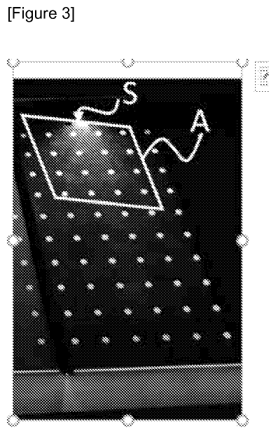

FIGS. 1 and 2 each show photographs of luminous glazings illuminated from above by blue (FIG. 1) and red (FIG. 2) light-emitting diodes, respectively. In each photograph, the glazing on the left comprises a prior art Cp-2 functional coating and the glazing on the right does not.

When blue LEDs are used, the pattern is visible on both glazings. However, the pattern remains less luminous when the glazing also features a functional coating.

When red diodes are used, the pattern quickly becomes invisible on the left glazing.

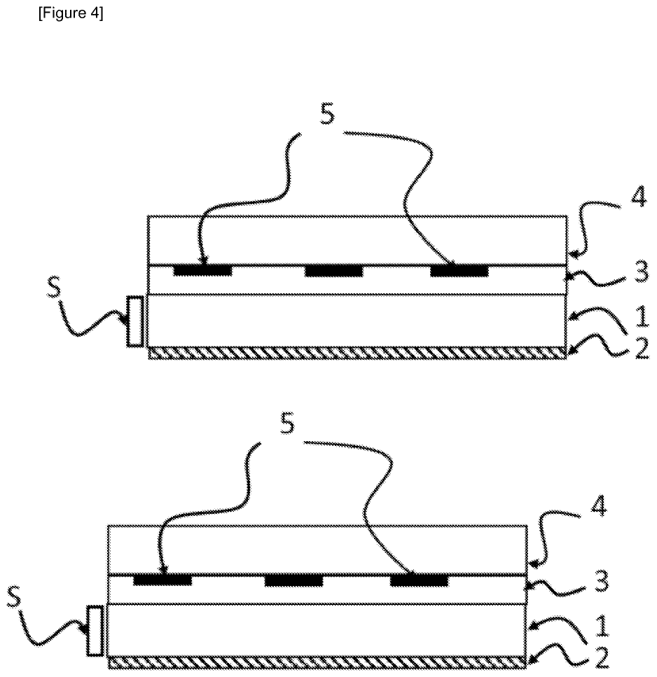

FIG. 3 shows a photograph of a luminous glazing comprising a functional coating of the prior art Cp-2 illuminated from above and in the center by white light-emitting diodes (element S). It comprises a diffusing layer in the form of dots. Light is injected from above and extracted along the propagation path by the scattering points. In this photograph, only the twelve dots in the square (element A) appear white. All the others appear cyan, a color on the verge between blue and green, with increasing blue-green intensity the further from the injection point.

### III. Characterization of the Guided-Mode Absorption Effect

The values Rgm, a*gm and b*gm in guided-mode reflection at the substrate/functional coating interface were determined. This reflection corresponds to an angle of incidence of 80° in the glass substrate.

By definition of the guided mode, whose propagation angle is greater than the system's critical angle, light cannot be transmitted through the coating. What is not reflected is therefore absorbed.

According to the invention, it is very useful to have as high an Rgm as possible, as this parameter denotes low absorption. Indeed, conserving the energy of a guided mode requires that Rgm+Agm=1, where Agm is the absorption of the guided mode. Low absorption results in high Rgm values. A higher Rgm value reflects both lower absorption, particularly in the red in the guided mode, and better preservation of the guided mode in terms of its total intensity.

The parameters a*gm and b*gm indicate the change in the colorimetric parameters of the light on reflection, for a white incident light, of the Illuminant D65 type.

A positive a*gm means that the reflection becomes redder than the incident ray.

A negative a*gm means that the reflection becomes greener than the incident ray.

A positive b*gm means that the reflection becomes more yellow than the incident ray.

A negative b*gm means that the reflection becomes bluer than the incident ray.

A reflection of a certain color indicates light absorption of the complementary color. So, for example, a negative a*gm means green reflection and red absorption.

The higher the absolute values of a* and b*, the more pronounced the color of the reflections/absorptions.

According to the invention, less negative or even neutral values of a*gm and b*gm are sought.

A functional coating is particularly suitable for use in a luminous glazing if:
the a*gm values range from −4 to 2, and
the b*gm values are greater than −2.

However, this must be weighed against the Rgm values. As explained above, a high Rgm indicates low absorption. This is why it can be beneficial to have structures with high Rgm values even if the associated a*gm and b*gm are higher in absolute value, as these colors will be less intense.

Table 4 summarizes the optical properties.

TABLE 4

| | Ex. 1 | Ex. 2 | Ex. 3 | Ex. 4 | Ex. 5 | Cp. 1 | Cp. 2 |
|---|---|---|---|---|---|---|---|
| TL | 89.8 | 86.3 | 88.6 | 90.3 | 87.2 | 89.3 | 88.5 |
| a*T | −0.9 | 0.1 | −0.6 | −0.8 | 0.5 | −0.4 | −0.2 |
| b*T | 0.0 | −0.2 | 0.1 | 1.1 | 0.7 | 2.7 | 0.6 |
| RLc | 5.4 | 9.1 | 6.1 | 4.7 | 7.4 | 7.1 | 6.9 |
| a*c | 0.0 | −5.1 | −1.8 | −0.1 | −8.4 | −1.5 | −4.0 |
| b*c | 2.6 | 2.8 | 2.0 | −5.4 | −2.2 | −11.0 | −0.8 |
| Rgm | 96.0 | 95.5 | 91.9 | 94.7 | 91.7 | 90.9 | 90.9 |
| a*gm | −2.8 | −3.2 | 1.0 | −1.9 | −0.1 | −4.0 | −5.3 |
| b*gm | 0.4 | −0.2 | 1.8 | 6.2 | 0.7 | −3.4 | −3.5 |

Prior art coatings of type Cp.1 and Cp.2 cannot be used in luminous glazings because they do not have a sufficiently stable color in the substrate in guided mode. The Rgm values are lower than the Rgm values of the examples according to the invention. In addition, their a*gm and b*gm values are too negative.

This explains why, when the light source is red light, the red light is observed to quickly fade the further away the light is injected (FIG. 2, left-hand photograph).

The functional coatings of the invention have:
Ex.1, Ex.2 and Ex.4: very high Rgm values and less negative a*gm and b*gm values than Cp. 1 and Cp.2,
Ex.3 and Ex.5: high Rgm values and neutral a*gm and b*gm values.

### IV. Configurations

FIG. 4 shows a luminous laminated glazing according to the invention. It comprises:
a material according to the invention (1) comprising a functional coating (2) located on the face 4 of the laminated glazing,
a lamination interlayer preferably made of PVB (3),
a second glass substrate (4),
a patterned diffusing layer (5),
a light source capable of injecting light into the substrate.

1. A material comprising a substrate coated with a functional coating comprising, starting from the substrate:
optionally a first dielectric coating below the functional layer comprising:
a layer with higher refractive index with an optical thickness of between 0 and 110 nm, and
a layer with lower refractive index with an optical thickness of between 0 nm and 170 nm,
the layer with higher refractive index of the optional first dielectric coating, has a higher refractive index than the layer with lower refractive index of the optional first dielectric coating, and the refractive index variation at 550 nm between these two layers is greater than 0.25,
a functional layer based on a transparent conductive oxide,
a second dielectric coating located above the functional layer comprising:
a layer with higher refractive index with an optical thickness of between 80 and 170 nm, and
a layer with lower refractive index with an optical thickness of between 80 and 190 nm,
the layer with higher refractive index of the second dielectric coating has a refractive index greater than that of the layer with lower refractive index of the second dielectric coating and the refractive index variation at 550 nm between these two layers is greater than 0.25,
a sum of optical thicknesses of the optional first dielectric coating and the second dielectric coating is greater than 200 nm.

2. The material according to claim 1, wherein the functional layer is selected from fluorine-doped tin oxide, antimony-doped tin oxide and/or indium tin oxide.

3. The material according to claim 1, wherein the dielectric layers of each dielectric coating of the optional first dielectric coating and the second dielectric coating with a lower refractive index have a refractive index less than 1.7.

4. The material according to claim 3, wherein the layers with lower refractive index are silicon oxide-based layers.

5. The material according to claim 1, wherein the dielectric layers of each dielectric coating of the optional first dielectric coating and the second dielectric coating with a higher refractive index have a refractive index greater than 1.9.

6. The material according to claim 1, wherein the layers of each dielectric coating of the optional first dielectric coating and the second dielectric coating with lower refractive index are chosen from among:
layers based on nitride of one or more elements selected from silicon, aluminum or zirconium,
layers based on zinc tin oxide,
zinc oxide-based layers, or
titanium oxide-based layers.

7. The material according to claim 1, wherein:
the optional first dielectric coating located below the functional layer comprises:
the layer with higher refractive index with an optical thickness of between 0 nm and 20 nm,
the layer with lower refractive index with an optical thickness of between 0 nm and 25 nm,
the second dielectric coating located above the functional layer comprises:
the layer with higher refractive index with an optical thickness of between 100 nm and 140 nm,
the layer with lower refractive index with an optical thickness of between 80 and 140 nm.

8. The material according to claim 1, wherein
the optional first dielectric coating located below the functional layer comprises:
the layer with higher refractive index with an optical thickness of between 40 nm and 110 nm,
the layer with lower refractive index with an optical thickness of between 20 nm and 145 nm,
the second dielectric coating located above the functional layer comprises:
the layer with higher refractive index with an optical thickness of between 80 nm and 170 nm,
the layer with lower refractive index with an optical thickness of between 125 and 190 nm.

9. The material according to claim 8, wherein the sum of the optical thicknesses of the optional first dielectric coating and the second dielectric coating is greater than 300 nm.

10. The material according to claim 8, wherein:
the optional first dielectric coating located below the functional layer comprises:
the layer with higher refractive index with an optical thickness of between 60 nm and 80 nm,
the layer with lower refractive index with an optical thickness of between 75 nm and 105 nm,
the second dielectric coating located above the functional layer comprises:
the layer with higher refractive index with an optical thickness of between 90 nm and 130 nm,
the layer with lower refractive index with an optical thickness of between 150 and 165 nm.

11. A laminated glazing comprising a material according to claim 1 and at least one second substrate, the material and the second substrate being interconnected by a laminating interlayer.

12. The laminated glazing according to claim 11, comprising a face 1 situated outside a building or vehicle which it equips, faces 2 and 3 in contact with the laminating interlayer and a face 4 on the inside of the building or vehicle, the functional coating being positioned on the face 4.

13. A luminous glazing comprising a laminated glazing according to claim 11, a light source optically coupled to form a light guide and a light extractor element for extracting the guided light.

14. The luminous glazing according to claim 13, wherein the light extractor element is a patterned diffusing layer element.

15. The luminous glazing according to claim 14, selected from a side window, rear window, roof window or windscreen.

16. The material according to claim 6, wherein the layers based on nitride of one or more elements are based on silicon nitride.
